(19) United States
(12) Patent Application Publication
(10) Pub. No.: US 2026/0022251 A1
(43) Pub. Date: Jan. 22, 2026

(54) FORMULATION

(71) Applicant: Merck Patent GmbH, Darmstadt (DE)

(72) Inventors: Manuel Hamburger, Mannheim (DE); Sophia Buhbut, Ashkelon (IL); Stephan Wieder, Frankfurt Am Main (DE); Oliver Doll, Dietzenbach (DE); Henning Seim, Darmstadt (DE)

(21) Appl. No.: 19/336,835

(22) Filed: Sep. 23, 2025

Related U.S. Application Data
(63) Continuation of application No. PCT/EP2024/057544, filed on Mar. 21, 2024.

(30) Foreign Application Priority Data
Mar. 23, 2023 (EP) 23163826.3

(51) Int. Cl. C09D 1/00; C01G 23/04; C09D 7/20; G02B 1/10

(52) U.S. Cl. CPC C09D 1/00; C01G 23/04; C09D 7/20; G02B 1/10

(57) ABSTRACT

A formulation for preparing an optical layer that includes a metal oxide includes a material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides, and a chemical compound represented by following chemical formula (I) as defined herein.

### CROSS REFERENCE TO RELATED APPLICATIONS

This application is a Continuation under 35 USC § 111 (a) of International Patent Application No. PCT/EP2024/057544 filed Mar. 21, 2024 which claims priority to the European Patent Application number 23163826.3, filed Mar. 23, 2023. The contents of these applications are incorporated herein by reference in their entirety.

### FIELD OF THE INVENTION

The present invention relates to a formulation for preparing an optical layer containing a metal oxide, method for preparing a formulation, use of a formulation, method for preparing a composite, a composite, an optical device and a display device.

### BACKGROUND ART

Leading edge optical devices typically include optical gratings made from composite materials having a substrate as a support and complex and interlaced patterns thereon, the patterns being made up of different layers or stacks of layers. Usually, the creation of such complex and interlaced patterns demands for structuring processes, which become increasingly challenging with decreasing size of structural dimensions to be prepared.

In addition to a wide range of possible uses in various fields of application, such as in spectrometers or in optical storage systems (CD, DVD, etc.), diffractive gratings are the core components of so-called XR devices, mostly glasses. In this context, R stands for the term reality and X denotes different attributes such as, for example, virtual, augmented, mixed and so forth. Hence, diffractive gratings form part of the core of the so-called optical engine in XR devices, specifically in augmented reality and mixed reality glasses. Virtual reality glasses, when built as a head mounted display, are often composed of a conventional liquid crystal (LC) organic light emitting diode (OLED) display being embedded in the device, and thus do not necessarily require diffractive gratings. In contrast, augmented and mixed reality glasses are designed that way to enable consumers to obtain visual impressions of their environment, at its best as if they would not wear any glasses at all. However, they also make it possible to provide and serve digital information and to also project it into the field of vision of individuals. Additional digital information is gathered from recognizing and analyzing the environment, the individual inspects or takes a look currently at. In order to convey and project supporting digital information into the eyes of an individual, the augmented or mixed reality glasses are equipped with an information supply unit, which is coupled to an optical waveguide system that transports the optically coded supporting information through it directly to the lens of the glasses. Here, the information passes a diffractive grating which couples the incident light into the lens and splits it according to its angular information and its spectral bands by diffraction. After incoupling of the light, the lens serves as waveguide enabling transport of the light to and into the pupil of an individual. The location of light incoupling is independent of any preferred position and thus of the implication of technical needs. The direction of traversal of light within the lenses is determined by the diffractive grating diffracting or splitting the light. At certain positions in the lens, a second and a third diffractive grating serves for changing the direction of light traversal and thereby enforcing the light to be projected into pupil of the user. The light traversal in the glasses is accomplished by total internal reflection (TIR) of the light, thus bouncing several times between the glass interfaces until reaching another diffractive grating, which changes the internal TIR direction of the light (see FIG. 2). The second and third grating are geometrically aligned in different directions with respect to the first and incoupling grating, e. g. by a certain angular distortion of the longitudinal axis, thus allowing to change the direction of propagation of totally internally reflected light. Needless to say, the lens itself or the material of which lenses are made of shall not be absorbing. Otherwise, the supportive information never reaches the pupil of the user or only with strongly depleted light intensity. The process works regardless of the use of reflection or transmission gratings. Usually, the lenses are equipped with both types of gratings to properly guide the light. It should also be mentioned that there are differences in the optical performance of reflection and transmission gratings, which, however, are of no further interest in the context of the current invention. The basic structure of the gratings is very similar, which is more important at this point.

Nevertheless, there are different designs and structures such as surface relief (SR) or volume phase holographic (VPH) gratings to achieve waveguide. Both types are very similar in appearance. In the simplest case, the gratings are somehow mounted onto the surface of a waveguiding material, here the lens. The grating itself is composed of an array of fine structures, mostly trenches of a first material type Material 01 with a refractive index RI 01, however, not limited thereto. The geometrical shape of the trenches may be manifold, from rectangular, over V-shaped trenches, U-shaped and there like. The width, including structures with different widths, the geometrical form of the trenches, their pitch as well as their depth, including different depths, are specially designed to influence the diffraction pattern of the incident light to be diffracted.

In case of VPH gratings, the trenches or structures of a first material type (Material 01) having a refractive index (RI 01) are filled by a second material type (Material 02) having a refractive index (RI 02), wherein RI 02 is incrementally different from RI 01 (see FIGS. 1 and 3). For the sake of completeness, it should be mentioned that Material 01 or Material 02 may be composed of a stack of structured layers, each containing a different material composition with different refractive index, stacked on top of each other, thereby forming Material 01 or Material 02 having an effective or graded refractive index RI 01 or RI 02, respectively. Incidentally, the (effective or graded) refractive indices RI 01 and RI 02 depend on the refractive index of the waveguide or the lens from which the glasses are made of. If a glass lens with high refractive index (n03>1.46) is used, the (effective or graded) refractive indices of Material 01 and Material 02 are considered to be higher than that of the lens itself, whereby a RI value of 2.0 can be reached and exceeded. Surface relief (SR) gratings may look similar and may also include a second type of material as a filler for the trenches, but the trenches can also be just air. High performance gratings, especially those of VPH-type, may be manufactured using standard lithography and deposition techniques known from micro-fabrication such as, for example, the manufacturing of integrated circuits.

Such standard techniques typically include physical vapor deposition (PVD) or chemical vapor deposition (CVD) processes and often suffer from incomplete gap filling due to unfavourable deposition and/or layer growth deposition properties including increased deposition and/or growth rates at corners and edges. Such incomplete gap filling results in the formation of voids within the structures to be filled by the PVD- and CVD-materials. In addition to the formation of voids, the surface of the substrate is covered by a PVD and/or CVD layer that is almost as thick as the maximum depth of the deepest structure to be filled by the deposited gap filling material (see FIGS. 4 and 5). In some applications, however, it may be necessary to expose the surface of the substrate so that it is available for further processing. Therefore, undesired overburden layers from PVD or CVD need to be removed, for example by chemical mechanical planarization (CMP) without harming the original substrate surface underneath. Although CMP is very well established in the process of manufacturing integrated circuits, CMP is a time consuming and costly process and can be seen as a potential economic drawback for mass production of leading-edge optical devices, particularly the mass production of diffractive gratings. It would therefore be desirable to have a solution for an advanced and cost-efficient manufacturing of optical gratings where gap filling does not require CMP (see FIG. 6).

For that reason, more cost-effective production technology allowing for lower cost of ownership is required.

### SUMMARY OF THE INVENTION

The inventors newly have found that there are still one or more of considerable problems for which improvement is desired, as listed below:
providing a printable formulation for preparing an optical layer/composite containing a material which provide sufficiently high refractive indices after curing;
   providing a formulation for preparing an optical layer which enable to prepare a densed and crack-less or crack-free optical layer, enable to fill up of cavities, trenches or gaps after curing;
providing a formulation for preparing an optical layer containing a precursor material of a high refractive index material, which enable to well disperses in the formulation; simpler and/or cost efficient method for preparing an optical layer/composite with using the formulation; realizing more stable formulation, no or less decomposition of co-solvent in the formulation, no or less viscosity change of the formulation, providing suitable formulation for ink jetting and/or realizing continuous inkjet printing.

The inventors aimed to solve one or more of the above-mentioned problems.

Then, the present inventors have surprisingly found that one or more of the above-described technical problems can be solved by the features as defined in the claims.

Namely, it is found a novel formulation for preparing an optical layer containing a metal oxide, preferably for preparing a composite, more preferably for preparing a layered composite, comprising at least;
a material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides; and
a chemical compound represented by following chemical formula (I).

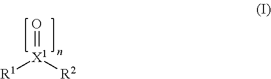

wherein

### X¹ is S or C;

n is 2 when X¹ is S, n is 1 when X¹ is C;
R¹ and R² are, independently of each other, selected from the group consisting of a straight-chain alkyl group having 1 to 25 carbon atoms, preferably 1 to 15 carbon atoms; a branched or cyclic alkyl group having 3-25 carbon atoms, preferably 3 to 15 carbon atoms; an aryl group having 3 to 25 carbon atoms, preferably from 3 to 25 carbon atoms; a straight chain alkyl-cycloalkyl group having 4 to 25 carbon atoms, preferably 4 to 15 carbon atoms; branched chain alkyl-cycloalkyl group having carbon atoms 6 to 25 carbon atoms, preferably 6 to 15 carbon atoms; a straight chain alkyl-aryl group having 4 to 25 carbon atoms, preferably 4 to 15 carbon atoms; branched chain alkyl-aryl group having 6 to 25 carbon atoms, preferably 6 to 15 carbon atoms;
where one or more non-adjacent CH₂ groups of the above-mentioned groups may be replaced by oxygen atom, C═O, C═S, C═Se, C═NH, SiH₂, SO, SO₂, OS, or CONH and where one or more H atoms may be replaced by D, F, Cl, Br, I, CN or NO₂;
where each of groups may be substituted by one or more groups Ra;

R^{a} is at each occurrence, identically or differently, H, D, a straight chain alkyl or alkoxy group having 1 to 15 carbon atoms, preferably 1 to 10 carbon atoms, more preferably 1 to 5 carbon atoms; a branched or cyclic alkyl or alkoxy group having 3 to 15 carbon atoms, preferably 3 to 10 carbon atoms, more preferably 3 to 5 carbon atoms; a straight-chain alkenyl or alkynyl group having 2 to 15 carbon atoms, preferably 2 to 10 carbon atoms, more preferably 2 to 5 carbon atoms; a branched alkenyl group or alkynyl group having 3 to 15 carbon atoms, preferably 3 to 10 carbon atoms, more preferably 3 to 5 carbon atoms; an aromatic or heteroaromatic ring system having 5 to 15 aromatic ring atoms, preferably 5 to 10 aromatic ring atoms; where in each of the above-mentioned groups, one or more H atoms may be replaced by D, F, Cl, Br, I, and where two or more adjacent substituents R^{a} here may optionally form a mono- or polycyclic, aliphatic ring system with one another.

In another aspect, the present invention further relates to method for preparing a formulation of the present invention, containing at least the following step;
(X) mixing a material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides; and
a chemical compound of chemical formula (I).

In another aspect, the present invention also relates to use of the formulation of the present invention for preparing an optical layer containing a metal oxide, preferably for preparing a composite, more preferably for preparing a layered composite.

In another aspect, the present invention further relates to a method for preparing a composite containing a metal oxide, preferably said metal oxide is selected from metal dioxide, metal mono oxide, or a combination of these; comprising the following steps (a) and (b):
providing the formulation of the present invention onto a surface of a substrate, preferably by wet deposition process, more preferably by spin-coating or ink-jetting, even more preferably by ink-jetting; and
applying a thermal treatment to the formulation provided on the surface of the substrate to convert at least a part of the material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides of the formulation to a metal oxide.

In another aspect, the present invention further relates to a composite, preferably being a layered composite, preferably said layered composite is an optical layer, obtained or obtainable by the method of the present invention.

In another aspect, the present invention further relates to an optical device comprising the composite of the present invention, and a patterned substrate comprising topographical features on the surface thereof.

In another aspect, the present invention further relates to a display device comprising at least one functional medium configured to modulate a light or configured to emit light; and the composite of the present invention.

### Technical Effects of the Invention

The present invention provides one or more of following effects;
providing a printable formulation for preparing an optical layer/composite containing a material which provide sufficiently high refractive indices after curing;
providing a formulation for preparing an optical layer which enable to prepare a dense and crack-less or crack-free optical layer, enable to fill up of cavities, trenches or gaps after curing;
providing a formulation for preparing an optical layer containing a precursor material of a high refractive index material, which enable to well disperses in the formulation; simpler and/or cost efficient method for preparing an optical layer/composite with using the formulation; realizing more stable formulation, no or less decomposition of co-solvent in the formulation, no or less viscosity change of the formulation, providing suitable formulation for ink jetting and/or realizing continuous inkjet printing.

Preferred embodiments of the present invention are described hereinafter and in the dependent claims.

### BRIEF DESCRIPTION OF THE FIGURES

FIG. 1: Schematic cross-sectional view of a VPH grating with a Material 01 and a Material 02, wherein the refractive index IR 01 of Material 01 is incrementally different to the refractive index IR 02 of Material 02.

FIG. 2: Schematic cross-sectional view of a VPH grating enabling light diffraction (transmissive case) including propagation of diffracted light within waveguide (e.g. lens) by total internal reflection.

FIG. 3: Schematic cross-sectional view of a VPH grating providing gaps (trenches) to be filled with a high refractive index material (Material 02), wherein the refractive index of Material 02 is incrementally different form the refractive index of Material 01 flanking the gaps (trenches).

FIG. 4: Schematic representation of PVD- or CVD-mediated gap filling process and removal of undesired overburden.

FIG. 5: Schematic representation of PVD- or CVD-mediated gap filling process creating and leaving voids within gaps and deposited layers.

FIG. 6: Schematic representation of gap filling process using formulations containing inventive metal complex or formulations thereof being converted to metal oxides.

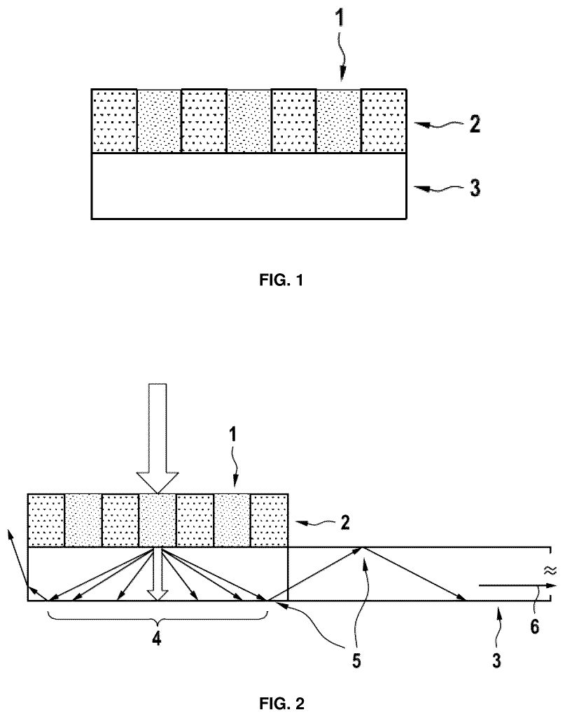

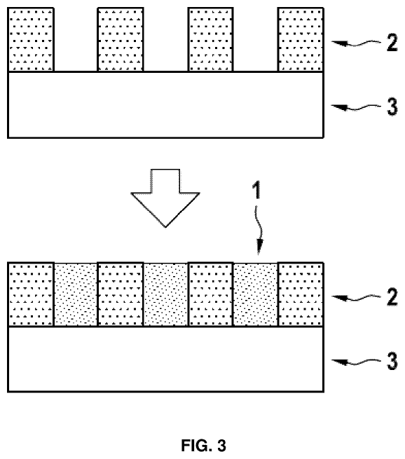

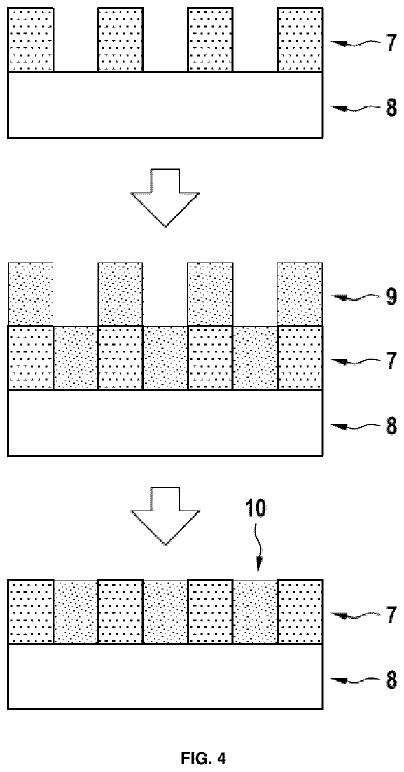

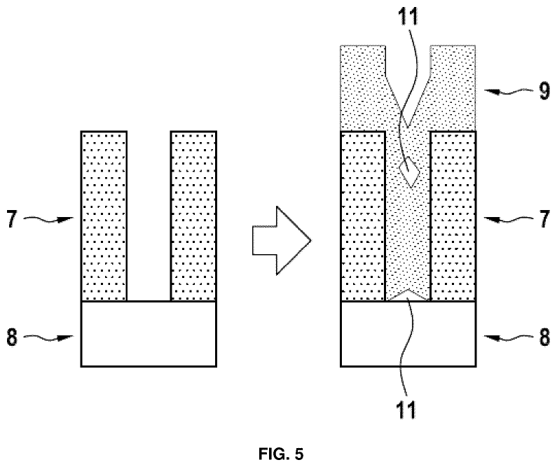

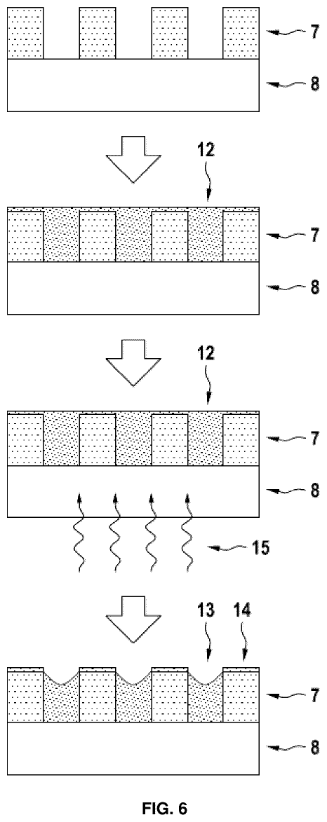

### LIST OF REFERENCE SIGNS

1. Material 02 with RI 02
2. Material 01 with RI 01
3. Substrate (e.g. glass)
4. Diffraction of incident light represented by broad arrow
5. Total internal reflection of light (TIR)
6. Waveguide
7. Structured layer stack with gaps (trenches)
8. Substrate (e.g. glass or silicon)
9. Overburden of material (e.g. high refractive index material or high etch resistant material)
10. Material (e.g. high refractive index material or high etch resistant material) providing gap fill
11. Voids
12. Formulation (e.g. ink) of high refractive index material (e.g. metal oxide precursor)
13. High refractive index material (e.g. metal oxide) providing gap fill with optional concave geometry
14. Overburden layer (optional)
15. Energy

### Definition of the Terms

In the context of the present invention, the term “formulation medium” or the plural term “formulation media” as used herein, denote one or more compounds serving as a solvent, suspending agent, carrier and/or matrix for the polyoxometalate compound and any other component included in the formulation. Formulation media are generally inert compounds that do not react with said polyoxometalate compounds and said other components. Formulation media may be liquid compounds, solid compounds or mixtures thereof. Typically, formulation media are organic compounds.

The term “surfactant” as used herein, refers to an additive that reduces the surface tension of a given formulation.

The term “wetting and dispersion agent” as used herein, refers to an additive hat increases the spreading and penetrating properties of a given formulation. In this way, the tendency of the molecules to adhere to each other is reduced.

The term “adhesion promoter” as used herein, refers to an additive that increases the adhesion of a given formulation.

The term “polymer matrix” as used herein, refers to an additive that acts as a macromolecular matrix for one or more components of a given formulation.

The term “optical device” as used herein, relates to a device containing one or more optical components for forming a light beam including, but not limited to, gratings, lenses, prisms, mirrors, optical windows, filters, polarizing optics, UV and IR optics, and optical coatings. Preferred optical devices in the context of the present invention are augmented reality (AR) glasses and/or virtual reality (VR) glasses.

The term “display device” as used herein, is a kind of an optical device configured to output/present information in visual or tactile form. Examples are Liquid crystal display (LCD), Light emitting diode display (LED display), organic light emitting display (OLED), micro LED display, quantum dot display (QLED), AR/VR display, plasma (PDP) display, electroluminescent (ELD) display.

### DETAILED DESCRIPTION OF THE INVENTION

The present invention relates to a formulation for preparing an optical layer containing a metal oxide, preferably for preparing a composite, more preferably for preparing a layered composite, comprising at least, essentially consisting of, or consisting of;
a material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides; and
a chemical compound represented by following chemical formula (I).

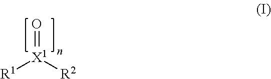

wherein

### X¹ is S or C;

n is 2 when X¹ is S, n is 1 when X¹ is C;
R¹ and R² are, independently of each other, selected from the group consisting of a straight-chain alkyl group having 1 to 25 carbon atoms, preferably 1 to 15 carbon atoms; a branched or cyclic alkyl group having 3-25 carbon atoms, preferably 3 to 15 carbon atoms; an aryl group having 3 to 25 carbon atoms, preferably from 3 to 25 carbon atoms; a straight chain alkyl-cycloalkyl group having 4 to 25 carbon atoms, preferably 4 to 15 carbon atoms; branched chain alkyl-cycloalkyl group having carbon atoms 6 to 25 carbon atoms, preferably 6 to 15 carbon atoms; a straight chain alkyl-aryl group having 4 to 25 carbon atoms, preferably 4 to 15 carbon atoms; branched chain alkyl-aryl group having 6 to 25 carbon atoms, preferably 6 to 15 carbon atoms;
where one or more non-adjacent CH₂ groups of the above-mentioned groups may be replaced by oxygen atom, C═O, C═S, C═Se, C═NH, SiH₂, SO, SO₂, OS, or CONH and where one or more H atoms may be replaced by D, F, Cl, Br, I, CN or NO₂;
where each of groups may be substituted by one or more groups R^{a};

R^{a} is at each occurrence, identically or differently, H, D, a straight chain alkyl or alkoxy group having 1 to 15 carbon atoms, preferably 1 to 10 carbon atoms, more preferably 1 to 5 carbon atoms; a branched or cyclic alkyl or alkoxy group having 3 to 15 carbon atoms, preferably 3 to 10 carbon atoms, more preferably 3 to 5 carbon atoms; a straight-chain alkenyl or alkynyl group having 2 to 15 carbon atoms, preferably 2 to 10 carbon atoms, more preferably 2 to 5 carbon atoms; a branched alkenyl group or alkynyl group having 3 to 15 carbon atoms, preferably 3 to 10 carbon atoms, more preferably 3 to 5 carbon atoms; an aromatic or heteroaromatic ring system having 5 to 15 aromatic ring atoms, preferably 5 to 10 aromatic ring atoms; where in each of the above-mentioned groups, one or more H atoms may be replaced by D, F, Cl, Br, I, and where two or more adjacent substituents R^{a} here may optionally form a mono- or polycyclic, aliphatic ring system with one another.

### Material

In a preferable embodiment of the present invention, the material used in the formulation is selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides.

In a preferable embodiment of the present invention, said metal of the material is a group 4 element of the periodic table, more preferably it is Ti or Zr. More preferably the material is selected from one or more members of the group consisting of Zirconium phosphate, Titanyl sulfate (Titanium oxysulfate), Titanium oxychloride, Titanium oxy fluoride, Zirconium oxysulfate, Zirconium oxychloride, Zirconium oxy fluoride and hydrates of any one of them.

In some embodiments of the present invention, the formulation may further contain another material which is different from the material indicated above. Said another material is selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides. Here, the metal of said another material is a group 4 element of the periodic table, more preferably it is Ti or Zr. More preferably said another material is selected from one or more members of the group consisting of Zirconium phosphate, Titanyl sulfate (Titanium oxysulfate), Titanium oxychloride, Titanium oxy fluoride, Zirconium oxysulfate, Zirconium oxychloride, Zirconium oxy fluoride and hydrates of any one of them.

Preferably, the total content of the material in the formulation is in the range from 0.1% to 70% (w/w), based on the total mass of the formulation, preferably it is from 1 wt % to 50 wt %, more preferably from 5 to 40 wt %. Here, when anhydrous metal oxy salt is used as the material, the total content of anhydrous metal oxy salt in the formulation is preferably in the above-mentioned range.

It is believed that the material of the present invention provides high refractive index value when it is used in the formulation for preparing an optical layer, preferably it further realizes a lower parasitic absorption of an optical layer/composite made from the formulation.

It is also believed that said material of the present invention can be well dispersed or dissolved in a formulation and it is preferable for wet deposition process.

### Chemical Compound of Formula (I)

According to the present invention, said compound of formula (I) is used in the formulation.

It is believed that the compound of formula (I) realizes more stable formulation, no or less decomposition of co-solvent in the formulation, no or less viscosity change of the formulation, providing suitable formulation for ink jetting and/or realizing continuous inkjet printing.

In a preferable embodiment of the present invention, the compound of formula (I) is represented by following chemical formula (II) or (III).

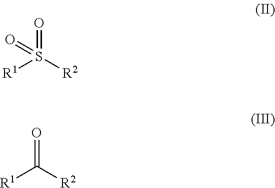

More preferably, said compound of formula (I) is selected from the group consisting of

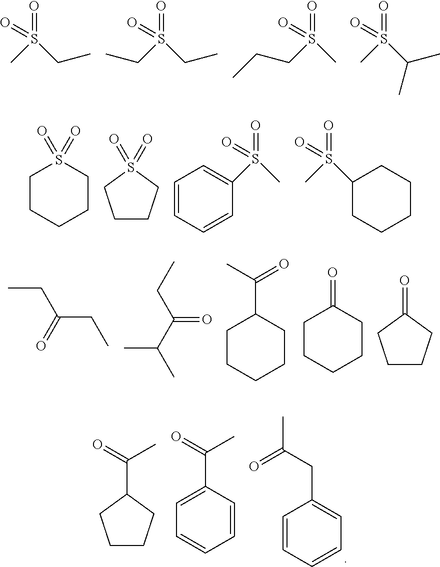

Preferably formula (I) is formula (II) selected from the group consisting of

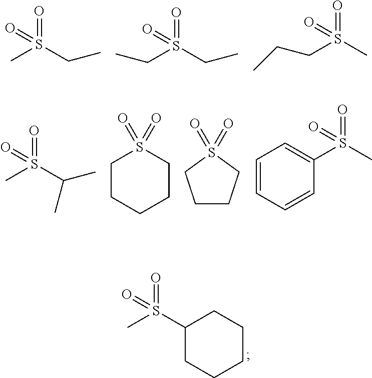

or preferably, formula (I) is formula (III), selected from the group consisting of

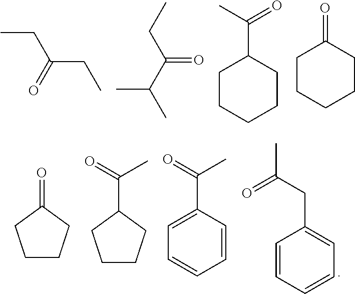

In a preferable embodiment of the present invention, the amount of said chemical compound of formula (I) is in the range from 0.01 to 99 wt % based on the total amount of the formulation, preferably 0.1 to 50 wt %, more preferably 1 to 25 wt %, even more preferably 5 to 15 wt %.

Preferably the formulation contains a solvent selected from water or an organic solvent, or the formulation contains a mixture of water and one more of organic solvents, and the total amount of the chemical compound of formula (I) in the formulation is in the range from 0.01 to 99 wt % based on the total amount of the formulation, preferably 0.1 to 50 wt %, more preferably 1 to 25 wt %, even more preferably 5 to 15 wt %.

### Solvent

In a preferred embodiment of the present invention, the formulation contains a solvent selected from water or an organic solvent, or a mixture of water and one more of organic solvents. Preferably the formulation contains the mixture of water and one or more organic solvents. More preferably, the formulation contains the mixture of water, one or more organic solvents and the chemical compound of the formula (I) as a co-solvent of the mixture. Preferably said organic solvent is each independently selected from one or more members of the group consisting of ethylene glycol monoalkyl ethers, preferably it is ethylene glycol monomethyl ether, ethylene glycol monoethyl ether, ethylene glycol monopropyl ether and/or ethylene glycol monobutyl ether; diethylene glycol dialkyl ethers, preferably it is diethylene glycol dimethyl ether, diethylene glycol diethyl ether, diethylene glycol dipropyl ether and/or diethylene glycol dibutyl ether; propylene glycol monoalkyl ethers, preferably it is propylene glycol monomethyl ether (PGME), propylene glycol monoethyl ether and/or propylene glycol monopropyl ether; ethylene glycol alkyl ether acetates, preferably it is methyl cellosolve acetate and/or ethyl cellosolve acetate; propylene glycol alkyl ether acetates, preferably it is propylene glycol monomethyl ether acetate (PGMEA), propylene glycol monoethyl ether acetate and/or propylene glycol monopropyl ether acetate; ketones, preferably it is methyl ethyl ketone, acetone, methyl amyl ketone, methyl isobutyl ketone and/or cyclohexanone; alcohols, preferably it is ethanol, propanol, butanol, hexanol, cyclo hexanol, ethylene glycol, propylene glycol, triethylene glycol and/or glycerin; esters, preferably it is ethyl 3-ethoxypropionate, methyl 3-methoxypropionate and/or ethyl lactate; and cyclic esters, preferably it is gamma-butyro-lactone; preferably said solvent is ethylene glycol monoalkyl ethers, diethylene glycol dialkyl ethers, propylene glycol, ethylene glycol, propylene glycol monoalkyl ethers, ethylene glycol alkyl ether acetates, propylene glycol alkyl ether acetate, more preferably said solvent is selected from propylene glycol alkyl ether acetates, ethylene glycol monoalkyl ethers, propylene glycol and propylene glycol monoalkyl ethers.

It is believed that the printing, especially ink jetting of structures is considered as a highly cost-efficient production step. Thus, suitable solvents of the formulation for printing the structures or filling up of cavities and structures, is described here.

Formulations of metal oxides or printable metal oxides are usually composed of a solvent or a blend of solvents in which the respective precursor of a metal oxide is dissolved. However, in most cases, the high refractive index metal oxides are not soluble in formulations and unless suspension of metal oxide particles are not desirable to become used.

Thus, according to the present invention, said material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chloride is used as a metal oxide precursor in the formulation together with the solvent described above.

After printing, deposition and fill up of structures, at least a part of the material as the metal oxide precursor need to become converted into the respective metal oxides by any known means know to the persons skilled in the art (thermally, photochemically, etc.).

### Additives

In some embodiments of the present invention, the formulation may optionally comprise one or more additives selected from surfactants, wetting and dispersion agents, adhesion promoters, and polymer matrices.

Preferred surfactants are surface active substances, which preferably include surface active metal oxides and/or surface-active organic compounds. Surface-active organic compounds may include nonionic surfactants, anionic surfactants, and ampholytic surfactants and they may be coordinating or non-coordinating.

Examples of nonionic surfactants include, polyoxyethylene alkyl ethers, such as polyoxyethylene lauryl ether, polyoxyethylene oleyl ether and 30 polyoxyethylene acetyl ether; polyoxyethylene fatty acid diester; polyoxyethylene fatty acid monoester; polyoxyethylene polyoxypropylene block polymer; acetylene alcohol; acetylene glycol; polyethoxylate of acetylene alcohol; acetylene glycol derivatives, such as polyethoxylate of acetylene glycol; fluorine-containing surfactants, for example, FLUORAD (trade name, manufactured by Sumitomo 3M Limited), MEGAFAC (trade name: manufactured by DIC Cooperation), SURFLON (trade name, 5 manufactured by Asahi Glass Co. Ltd); or organosiloxane surfactants, for example, KP341 (trade name, manufactured by Shin-Etsu Chemical Co., Ltd.), and the like. Examples of said acetylene glycol include 3-methyl-1-butyne-3-ol, 3-methyl-1-pentyn-3-ol, 3,6-dimethyl-4-octyne-3,6-diol, 2,4,7,9-tetramethyl-5-decyne-4,7-diol, 3,5-dimethyl-1-hexyne-3-ol, 2,5-dimethyl-3-10 hexyne-2,5-diol, 2,5-dimethyl-2,5-hexane-diol, and the like.

Examples of anionic surfactants include ammonium salt or organic amine salt of alkyl diphenyl ether disulfonic acid, ammonium salt or organic amine salt of alkyl diphenyl ether sulfonic acid, ammonium salt or organic amine 15 salt of alkyl benzene sulfonic acid, ammonium salt or organic amine salt of polyoxyethylene alkyl ether sulfuric acid, ammonium salt or organic amine salt of alkyl sulfuric acid, and the like.

Examples of amphoteric surfactants include 2-alkyl-N-carboxymethyl-N-20 hydroxyethyl imidazolium betaine, lauric acid amide propyl hydroxy sulfone betaine, and the like.

Preferred surface-active metal oxides are selected from the list consisting of aluminum oxide, calcium oxide, silica, and zinc oxide. Such surface-active metal oxides are preferably present as fine powders, more preferably as nanoparticles, which are optionally surface treated.

Preferred surface-active organic compounds are surface-active non-polymeric compounds or surface-active polymeric organic compounds, wherein said surface-active non-polymeric compounds are preferably selected from the list consisting of alcohols, alkoxylates, aromatics, ketones, esters, modified urea, silanes, siloxanes and soap-based foam stabilizers, which are optionally functionalized and/or modified; and wherein said surface-active polymeric compounds are preferably selected from the list consisting of hydroxy polyesters, maleinate resins, polyacrylates, polyethers, polyester, polysilanes, silicone resins, and waxes, which are optionally functionalized and/or modified; and which are optionally present as copolymers. In a preferred embodiment, the surface-active organic compound is used as a solution.

Preferred silanes are polyether-modified silanes, polyester-modified silanes, and polyether-polyester-modified silanes. Preferred siloxanes are polyether-modified siloxanes, polyester-modified siloxanes, and polyether-polyester-modified siloxanes.

Preferred polyacrylates are modified polyacrylates, preferably silicone-modified polyacrylates, polyether macromer-modified polyacrylates, and silicone and polyether macromer-modified polyacrylates, which are optionally present as copolymers.

Preferred polysilanes are polyether-modified polysilanes (e.g. PEG-Silane 6-9), polyester-modified polysilanes, and polyether-polyester-modified polysilanes.

Preferred silicone resins are polyether-modified polysiloxanes, preferably polyether-modified polydialkyl siloxanes, more preferably polyether-modified polymethylalkylsiloxanes, and most preferably polyether-modified polydimethylsiloxanes and polyether-modified, hydroxy-functional polydimethylsiloxanes; polyester-modified polysiloxanes, preferably polydialkylsiloxanes, more preferably polyester-modified polymethylalkylsiloxanes, and most preferably polyester-modified polydimethylsiloxanes and polyester-modified, hydroxy-functional polydimethylsiloxanes; polyether-polyester-modified polysiloxanes, preferably polyether-polyester-modified polydialkylsiloxanes, more preferably polyether-polyester-modified polymethylalkylsiloxanes, and most preferably polyether-polyester-modified polydimethylsiloxanes and polyether-polyester-modified, hydroxy-functional polydimethylsiloxanes; epoxy functional polysiloxanes, preferably epoxy functional polydialkylsiloxanes, more preferably epoxy functional polymethylalkylsiloxanes, and most preferably epoxy functional polydimethylsiloxanes; acryl functional polysiloxanes, preferably acryl functional polydialkylsiloxanes, more preferably acryl functional polymethylalkylsiloxanes, and most preferably acryl functional polydimethylsiloxanes; polyether-modified, acryl functional polysiloxanes, preferably polyether-modified, acryl-functional polydialkylsiloxanes, more preferably polyether-modified, acryl-functional polymethylalkylsiloxanes, and most preferably polyether-modified, acryl-functional polydimethylsiloxanes; polyester-modified, acryl-functional polysiloxanes, preferably polyester-modified, acryl-functional polydialkylsiloxanes, more preferably polyester-modified, acryl-functional polymethylalkylsiloxanes, and most preferably polyester-modified, acryl-functional polydimethylsiloxanes; and aralkyl-modified polysiloxanes, preferably aralkyl-modified polydialkylsiloxanes, more preferably aralkyl-modified polymethylalkylsiloxanes, and most preferably aralkyl-modified polydimethylsiloxanes; which are optionally present as copolymers.

Preferred surfactants are commercially available from BYK-Chemie GmbH, Wesel, Germany and offered as surface additives. Preferred surfactants are DISPERBYK (hereafter “BYK”) surfactants selected from BYK-300, BYK-301, BYK-302, BYK-306, BYK-307, BYK-310, BYK-313, BYK-315 N, BYK-320, BYK-322, BYK-323, BYK-325 N, BYK-326, BYK-327, BYK-329, BYK-330, BYK-331, BYK-332, BYK-333, BYK-342, BYK-345, BYK-346, BYK-347, BYK-348, BYK-349, BYK-350, BYK-352, BYK-354, BYK-355, BYK-356, BYK-358 N, BYK-359, BYK-360 P, BYK-361 N, BYK-364 P, BYK-366 P, BYK-368 P, BYK 370, BYK 375, BYK-377, BYK-378, BYK-381, BYK-390, BYK-392, BYK-394, BYK-399, BYK-2616, BYK-3400, BYK-3410, BYK-3420, BYK-3450, BYK-3451, BYK-3455, BYK-3456, BYK-3480, BYK-3481, BYK-3499, BYK-3550, BYK-3560, BYK-3565, BYK-3566, BYK-3750, BYK-3751, BYK-3752, BYK-3753, BYK-3754, BYK-3760, BYK-3761, BYK-3762, BYK-3763, BYK-3764, BYK-3770, BYK-3771, BYK-3780, BYK-3900 P, BYK 3902 P, BYK-3931 P, BYK 3932 P, BYK-3933 P, BYK-8020, BYK-8070, BYK-9890, BYK-DYNWET 800, BYK-S 706, BYK-S 732, BYK-S 740, BYK-S 750 N, BYK-S 760, BYK-S 780, BYK-S 782, BYK-SILCELAN 3700, BYK-SILCLEAN 3701, BYK-SILCLEAN 3710, BYK-SILCLEAN 3720, BYK-UV 3500, BYK-UV 3505, BYK-UV 3510, BYK-UV 3530, BYK-UV 3535, BYK-UV 3570, BYK-UV 3575, BYK-UV 3576; BYKETOL series such as BYKETOL-AQ, BYKETOL-OK, BYKETOL-PC, BYKETOL-SPECIAL, BYKETOL-WA, NANOBYK series such as NANOBYK-3603, NANOBYK-3605, NANOBYK-3620, NANOBYK-3650, NANOBYK-3652, and NANOBYK-3822.

The wetting and dispersion agents used in the present invention are additives, which provide both wetting and/or stabilizing effects for formulations containing fine solid particles. They result in a fine and homogenous distribution of solid particles in a formulation media, preferably liquid formulation media, and ensure long-term stability of such systems. The formulation media may comprise water and the entire range of organic solvents of varying polarity. Moreover, they result in an improved wetting of solids and prevent particles from flocculating by various mechanisms (e.g. by electrostatic effects, steric effects, etc.).

Preferably, the wetting and dispersion agents are organic polymers or organic copolymers having polar functional groups selected from amino groups; amide groups; carbamate groups; carbonate groups; acidic groups, preferably boric acid groups, boronic acid groups, carboxylic acid groups, sulfuric acid groups, sulfonic acid groups, phosphoric acid groups, phosphonic acid groups, and phosphinic acid groups; ester groups, preferably boric ester groups, boronic ester groups, carboxylic ester groups, sulfuric ester groups, sulfonic ester groups, phosphoric ester groups, phosphonic ester groups, and phosphinic ester groups; ether groups; hydroxy groups; keto groups; and urea groups; wherein the organic polymers or copolymers may be present as a conjugate, derivative and/or salt, preferably as a salt. Preferred salts are ammonium salts, alkyl ammonium salts, alkylol ammonium salts, or alkaline metal salts such as preferably Li, Na, K and Rb salts. The polar functional groups may be also referred to as pigment-affinic groups or as filler-affinic groups. In a preferred embodiment, the wetting and dispersion agent is used as a solution.

More preferably, the wetting and dispersion agents are organic polymers or organic copolymers selected from acrylates; amides; carboxylic acids; and esters; wherein the organic polymers or copolymers may be present as a conjugate, derivative and/or salt, preferably as a salt; and wherein they may be further functionalized with one or more polar functional group as described above. Preferred salts are ammonium salts, alkyl ammonium salts, alkylol ammonium salts, or alkaline metal salts such as preferably Li, Na, K and Rb salts. In a preferred embodiment, the wetting and dispersion agent is used as a solution.

The wetting and dispersion agents may be present as a mixture, preferably as a mixture with a polysiloxane copolymer.

Preferred wetting and dispersing agents are commercially available from BYK-Chemie GmbH, Wesel, Germany. Preferred wetting and dispersing agents are ANTI-TERRA-202, ANTI-TERRA-203, ANTI-TERRA-204, ANTI-TERRA-205, ANTI-TERRA-210, ANTI-TERRA-250, ANTI-TERRA-U, ANTI-TERRA-U 80, ANTI-TERRA-U 100, BYK-151, BYK-153, BYK-154, BYK-155/35, BYK-156, BYK-220 S, BYK-1160, BYK-1162, BYK-1165, BYK-9076, BYK-9077, BYK-GO 8702, BYK-GO 8720, BYK-P 104, BYK-P 104 S, BYK-P 105, BYK-SYNERGIST 2100, BYK-SYNERGIST 2105, BYK-W 900, BYK-W 903, BYK-W 907, BYK-W 908, BYK-W 909, BYK-W 940, BYK-W 961, BYK-W 966, BYK-W 969, BYK-W 972, BYK-W 974, BYK-W 980, BYK-W 985, BYK-W 995, BYK-W 996, BYK-W 9010, BYK-W 9011, BYK-W 9012, BYKJET-9131, BYKJET-9132, BYKJET-9133, BYKJET-9142, BYKJET-9150, BYKJET-9151, BYKJET-9152, BYKJET-9170, BYKJET-9171, BYKUMEN, DISPERBYK, DISPERBYK-101 N, DISPERBYK-102, DISPERBYK-103, DISPERBYK-106, DISPERBYK-107, DISPERBYK-108, DISPERBYK-109, DISPERBYK-110, DISPERBYK-111, DISPERBYK-115, DISPERBYK-118, DISPERBYK-130, DISPERBYK-140, DISPERBYK-142, DISPERBYK-145, DISPERBYK-161, DISPERBYK-162, DISPERBYK-162 TF, DISPERBYK-163, DISPERBYK-163 TF, DISPERBYK-164, DISPERBYK-165, DISPERBYK-166, DISPERBYK-167, DISPERBYK-167 TF, DISPERBYK-168, DISPERBYK-168 TF, DISPERBYK-169, DISPERBYK-170, DISPERBYK-171, DISPERBYK-174, DISPERBYK-180, DISPERBYK-181, DISPERBYK-182, DISPERBYK-184, DISPERBYK-185, DISPERBYK-187, DISPERBYK-190, DISPERBYK-190 BF, DISPERBYK-191, DISPERBYK-192, DISPERBYK-193, DISPERBYK-194 N, DISPERBYK-199, DISPERBYK-199 BF, DISPERBYK-2000, DISPERBYK-2001, DISPERBYK-2008, DISPERBYK-2009, DISPERBYK-2010, DISPERBYK-2012, DISPERBYK-2013, DISPERBYK-2014, DISPERBYK-2015, DISPERBYK-2015 BF, DISPERBYK-2018, DISPERBYK-2019, DISPERBYK-2022, DISPERBYK-2023, DISPERBYK-2025, DISPERBYK-2026, DISPERBYK-2030, DISPERBYK-2050, DISPERBYK-2055, DISPERBYK-2059, DISPERBYK-2060, DISPERBYK-2061, DISPERBYK-2062, DISPERBYK-2070, DISPERBYK-2080, DISPERBYK-2081, DISPERBYK-2096, DISPERBYK-2117, DISPERBYK-2118, DISPERBYK-2150, DISPERBYK-2151, DISPERBYK-2152, DISPERBYK-2155, DISPERBYK-2155 TF, DISPERBYK-2157, DISPERBYK-2158, DISPERBYK-2159, DISPERBYK-2163, DISPERBYK-2163 TF, DISPERBYK-2164, DISPERBYK-2190, DISPERBYK-2200, DISPERBYK-2205, DISPERBYK-2290, DISPERBYK-2291, DISPERPLAST-1142, DISPERPLAST-1148, DISPERPLAST-1150, DISPERPLAST-1180, DISPERPLAST-I, and DISPERPLAST-P.

Preferred adhesion promoters are block copolymers, preferably high molecular weight block copolymers; copolymers with functional groups, preferably hydroxy-functional copolymers with acidic groups, styrene-ethylene/butylene-styrene block copolymer (SEBS) functionalized with maleic acid anhydride, carboxylated SEBS functionalized with maleic anhydride, SEBS functionalized with glycidyl methacrylate, polyolefin block copolymer functionalized with maleic acid anhydride, and ethylene octene copolymer functionalized with maleic anhydride; and polymers with functional groups, preferably polymers with acidic groups, and polypropylene functionalized with maleic anhydride. In a preferred embodiment, the adhesion promoter is used as a solution.

Preferred adhesion promoters are commercially available from BYK-Chemie GmbH, Wesel, Germany. Preferred adhesion promoters are BYK-4500, BYK-4509, BYK-4510, BYK-4511, BYK-4512, BYK-4513, SCONA TPKD 8102 PCC, SCONA TSIN 4013 GC, SCONA TSPOE 1002 GBLL, SCONA TPPP 2112 FA, SCONA TPPP 2112 GA, SCONA TPPP 8112 GA, SCONA TSKD 9103, SCONA TPPP 8112 FA, SCONA TPKD 8304 PCC, and SCONA TSPP 10213 GB.

Preferred polymer matrices are polymethyl methacrylate, polyvinylpyrrolidone, polycarbonate, polystyrene, polymethylpentene, and silicone.

A combination of two or more of the above-mentioned additives may be in the formulation.

In a preferred embodiment of the present invention, the content of the additives in the formulation is from 0% to ≤10% (w/w), preferably 0% to <9% (w/w), more preferably 0% to <7.5% (w/w), and most preferably 0% to <5.0 (w/w), based on the total mass of the formulation.

In some embodiments of the present invention, the formulation may optionally comprise one or more further metal complexes, which may act as further metal oxide precursors. In such case, a mixed optical metal oxide layer may be formed comprising a metal oxide obtained from the polyoxometalate compound and a further metal oxide obtained from the further metal oxide precursors.

In a preferred embodiment of the present invention, the formulation comprises one, two, three, four or more further metal complexes in addition to the polyoxometalate compound, where preferably each of the further metal complexes contains ligands selected from inorganic ligands or organic ligands. Preferred inorganic ligands are halogenides, phosphoric acid, sulfonic acid, nitric acid and water, which are optionally deprotonated. Preferred organic ligands are alcohols, carboxylic acids, cyanates, isocyanates, 1,3-diketones, beta-keto acids, beta-keto esters, organylphosphonic acids, organylsulfonic acids, oximes, hydroxamic acids, dihydroxy benzenes, hydroxybenzoic acids, dihydroxy benzoic acids, gallic acid, dihydroxynaphthalenes, anthracene diols, hydroxy-anthrones, anthracene triols, dithranols, halogenated hydrocarbons, aromatics, heteroaromatics, esters, catechols, coumarins and their derivatives, which are optionally deprotonated.

The presence of such further metal complexes allows to adjust certain properties of the optical metal oxide layer prepared therefrom such as e.g. material hardness, shrinkage, refractive index, transparency, absorbance, and haze suppression.

Preferably, the mass ratio (w/w) between the polyoxometalate compound and the one or more further metal complexes in the formulation is in the range from 1:100 to 100:1, preferably from 1:10 to 10:1, and more preferably from 1:5 to 5:1.

It is preferred that the total content of the polyoxometalate compound and the further metal complexes contained in the formulation is in the range from 0.1% to 50% (w/w), preferably 0.5% to 40% (w/w), more preferably 1% to 30% (w/w), based on the total mass of the formulation.

In a preferred embodiment of the present invention, the formulation is an ink formulation being suitable for inkjet printing. Typical requirements for ink formulations are surface tensions in the range from 20 mN/m to 30 mN/m and viscosities in the range from 5 mPa·s to 10 mPa·s.

### Method for Preparing a Formulation

In another aspect, the present invention also relates to a method for preparing a formulation of any one of the preceding claims, containing at least the following step;
(X) mixing at least a material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides; and
a chemical compound of chemical formula (I).
preferably a solvent selected from water or an organic solvent, or a mixture of water and one more organic solvent, is also mixed in step (X).
and optionally, the additive described above in the section of “additive” can also be mixed. Or in some embodiments, said additive is not mixed.

### Use

In another aspect, the present invention also relates to use of the formulation of the present invention for preparing an optical layer containing a metal oxide, preferably for preparing a composite, more preferably for preparing a layered composite.

### Method for Preparing a Composite Containing a Metal Oxide

In another aspect, the present invention also relates to a method for preparing a composite containing a metal oxide, preferably said metal oxide is selected from metal dioxide, metal mono oxide, or a combination of these; comprising the following steps (a) and (b):
providing the formulation of the present invention onto a surface of a substrate, preferably by wet deposition process, more preferably by spin-coating or ink-jetting, even more preferably by ink-jetting; and
(d) applying a thermal treatment to the formulation provided on the surface of the substrate to convert at least a part of the material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides, of the formulation to a metal oxide.

Preferably said composite being a layered composite, more preferably said layered composite is an optical layer.

### Step (a)

According to the present invention, said formulation may preferably be provided onto a surface of a substrate by wet deposition process. Said wet deposition process is drop casting, coating, or printing. A more preferred coating method is spin coating, spray coating, slit coating, or slot-die coating. A more preferred printing method is flexo printing, gravure printing, inkjet printing, EHD printing, offset printing, or screen printing. Furthermore preferred printing method is spray coating and inkjet printing and the most preferred one is inkjet printing.

Thus, in a preferred embodiment, the formulation is applied onto a surface of a substrate by spin-coating or ink-jetting in step (a). From a viewpoint of cost effective, ink-jetting can preferably be used.

In a preferred embodiment of the present invention, the formulation provided in step (a) of the method is an ink formulation being suitable for inkjet printing. Typical requirements for ink formulations are surface tensions in the range from 20 mN/m to 30 mN/m and viscosities in the range from 5 mPa·s to 10 mPa·s.

Depending on the specific problem to be solved, the formulation needs to be deposited either as a homogeneous, dense and thin layer covering the entire surface of the substrate by a coating method or the formulation needs to be deposited locally in a structured manner, thus requiring for a printing method. Both, coating and printing methods require formulations to be formulated in an adequate manner to comply with the physico-chemical needs of the respective coating and printing method as well as to comply with certain needs regarding the surface of the substrate to be coated or printed.

In a preferred embodiment of the method of the present invention, the surface of the substrate is pre-treated by a surface cleaning process. Preferred surface cleaning processes are silicon wafer cleaning processes such as described in W. Kern, The Evolution of Silicon Wafer Cleaning Technology, J. Electrochem. Soc., Vol. 137, 6, 1990, 1887-1892 and in New Process Technologies for Microelectronics, RCA Review 1970, 31, 2, 185-454. Such silicon wafer cleaning processes include wet cleaning process involving cleaning solvents (e.g. isopropanol (IPA)); wet etching processes involving hydrogen peroxide solutions (e.g. piranha solution, SC1, and SC2), choline solutions, or HF solutions; dry etching processes involving chemical vapor etching, UV/ozone treatments or glow discharge techniques (e.g. O₂ plasma etching); and mechanical processes involving brush scrubbing, fluid jet or ultrasonic techniques (sonification). The surface of the substrate can also be pre-treated by silanization or an atomic layer deposition (ALD) process. The pre-treatment of the surface of the substrate serves to modify the hydrophobicity/hydrophilicity of the surface. This can improve the adhesion and filling characteristics of the optical metal oxide layer on the surface of the substrate.

In a more preferred embodiment, a wet cleaning process involving cleaning solvents (e.g. isopropanol (IPA)) is combined with one or more of a wet etching process involving hydrogen peroxide solutions (e.g. piranha solution, SC1, and SC2), choline solutions, or HF solutions; dry etching process involving chemical vapor etching, UV/ozone treatments or glow discharge techniques (e.g. O₂ plasma etching); and mechanical process involving brush scrubbing, fluid jet or ultrasonic techniques (sonification).

In a most preferred embodiment, a wet cleaning process involving cleaning solvents (e.g. isopropanol (IPA)) is combined with a mechanical process involving brush scrubbing, fluid jet or ultrasonic techniques (sonification) and with a wet etching process involving hydrogen peroxide solutions (e.g. piranha solution, SC1, and SC2), choline solutions, or HF solutions;

Thus, in a preferable embodiment, in step (a), the formulation is applied to a surface of a substrate by spin-coating or ink-jetting.

In a preferable embodiment, the formulation is at least partly converted on the surface of the substrate to a composite, wherein said composite contains a metal oxide, preferably selected from metal dioxide and/or metal mono oxide; and a metal salt precursor.

In a preferable embodiment, the substrate is a patterned substrate comprising topographical features on the surface thereof.

### Step (b)

It is believed that the formulation, especially said material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides in the formulation is at least partly converted in step (b) on the surface of the substrate to a metal oxide to form a composite by exposure to thermal treatment. Said composite is preferably a layered composite. And said solvent is usually removed in step (b).

Preferred thermal treatment includes exposure to elevated temperature from 50 to 300° C., preferably it is from 80 to 250° C., more preferably from 100 to 200° C.

Thermal treatment is not limited to any specific thermal treatment methods or times. Depending on the type of substrate and formulation, a person skilled in the art is able to determine suitable thermal treatment methods.

In some embodiments of the method for preparing an optical metal oxide layer according to the present invention, the formulation is converted in step (c) on the surface of the substrate to an optical metal oxide layer by pre-baking (soft baking) at a temperature from 40 to 150° C., preferably from 50 to 120° C., more preferably from 60 to 100° C.; and then baking (hard baking, sintering or annealing) at a temperature from 150 to 600° C., preferably from 250 to 550° C., more preferably from 300 to 500° C.

Pre-baking (soft baking) serves the purpose to remove volatile and low boiling components such as e.g. volatile and low boiling formulation media or additives from the drop casted, coated or printed films. Pre-baking is preferably carried out for a period of 1 to 10 minutes. After pre-baking, layers of substrate adhering films of metal oxide precursor or metal oxide precursor mixtures are obtained. The films may still comprise residual formulation media or additives.

In an alternative preferred embodiment of the method for preparing an optical metal oxide layer according to the present invention, pre-baking is omitted so that the formulation is converted in step (c) on the surface of the substrate to an optical metal oxide layer directly by baking (hard baking, sintering or annealing) at a temperature from 150 to 600° C., preferably from 250 to 550° C., more preferably from 300 to 500° C.

Baking (hard baking, sintering or annealing) serves the purpose to convert the material as the metal oxide precursor or metal oxide precursor mixture layers on the substrate into a metal oxide layer. Moreover, the final properties of the metal oxide layer may be adjusted by the baking treatment. Baking is preferably carried out for a period of 1 to 300 minutes, preferably 1 to 60 minutes to achieve a refractive index (RI) of >1.7, preferably >1.8, more preferably >1.9, even more preferably >1.9, most preferably >2.0.

Pre-baking and baking may be carried out under ambient atmosphere or atmospheres with increased oxygen content in order to decompose unwanted organic components, which can lead to a lower activation energy when the composite is formed.

In a preferred embodiment of the method of present invention, the substrate is a patterned substrate comprising topographical features on the surface thereof, and the layered composite, preferably it is an optical layer, forms a coating layer covering the surface of the substrate and filling said topographical features. As a result, the topographical features are filled and levelled by said composition.

Preferred topographical features include, for example, gaps, grooves, trenches and vias. Topographical features may be distributed uniformly or non-uniformly over the surface of the substrate. Preferably, they are arranged as an array or grating on the surface of the substrate. It is preferred that the topographical features have different lengths, widths, diameters as well as different aspect ratios. It is preferred that said topographical features have an aspect ratio of 1:20 to 20:1, more preferably 1:10 to 10:1. The aspect ratio is defined as width of structure to its height (or depth). From the viewpoint of dimension, the depth of the topographical features is preferably in the range from 10 nm to 10 μm, more preferably 50 nm to 5 μm, and most preferably 100 nm to 1 μm.

It is also preferred that the topographical features are inclined at a certain angle, such as an angle from 10 to 80°, preferably from 20 to 60°, more preferably from 30 to 50°, most preferably about 40°. Such inclined topographical features are also referred to as slanted or blazed topographical features.

It may be also necessary to fill topographical features locally with optical metal oxide layer, either completely or to a certain level, but not to cover adjacent surfaces of the substrate, where no topographical features to be filled are available.

The substrate is preferably a substrate of an optical device. Preferred substrates are made of inorganic or organic base materials, preferably inorganic base materials. Preferred inorganic base materials contain materials selected from the list consisting of ceramics, glass, fused silica, sapphire, silicon, silicon nitride, quartz, and transparent polymers or resins. The geometry of the substrate is not specifically limited, however, preferred are sheets or wafers.

In step (a) of the method, the formulation is applied onto a surface of a substrate, wherein said surface may be either a surface of a base material of the substrate or a surface of a layer of a material being different from the base material of the substrate, wherein such layer has been formed prior to applying said formulation.

In this way, sequences of different layers (layer stacks) can be formed on top of one another. Such layer stacks may be also structured, wherein such structures typically have dimensions in the nanometer scale, at least with respect to diameter, width and/or aspect ratio.

Thus, in a preferable embodiment, in step (b), the formulation is at least partly converted on the surface of the substrate to a composite, preferably it is being of a layered composite, by baking it at a temperature from 50 to 300° C., preferably it is from 80 to 250° C., more preferably from 100 to 200° C.

### Composite

In another aspect, the present invention relates to a composite, preferably being a layered composite, preferably said layered composite is an optical layer, obtained or obtainable by the method of the present invention.

In a preferred embodiment of the present invention, the composite comprises at least a metal oxide derived from the formulation and the material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides as a non-converted part of the formulation used in step (a) of the method.

As indicated in the section of the material above, preferably said material is selected from metal oxy sulfate, metal oxy phosphate or metal oxy chloride, or a hydrate of any of these, preferably said metal of the material is a group 4 element of the periodic table, more preferably it is Ti or Zr. More preferably it is selected from the group consisting of Zirconium phosphate, Titanyl sulfate, Titanium oxychloride, Titanium oxy fluoride, Zirconium oxide sulfate, Zirconium oxychloride, Zirconium oxy fluoride.

Thus, preferably said metal of the metal oxide is Ti or Zr. More preferably said metal oxide is selected from the group consisting of Titanium oxide, Zirconium oxide or a combination of these.

### Optical Device

The present invention relates to an optical device comprising the composite of the present invention, which is preferably obtainable or obtained by the method of the present invention as described above. It is preferred that the optical device is a display device selected from an augmented reality (AR) and/or virtual reality (VR) device. Preferably said composite fills gap of said topographical features, more preferably said composite fills trench of the patterned substrate.

The present invention further relates to an optical device comprising the composite of the present invention, which is prepared by using the formulation according to the present invention as described above. It is preferred that the optical device is an augmented reality (AR) and/or virtual reality (VR) device. Preferably said composite fills gap of said topographical features, more preferably said composite fills trench of the patterned substrate.

### Display Device

Finally, the present invention relates to display device comprising at least one functional medium configured to modulate a light or configured to emit light; and the composite, or an optical device of the present invention.

Examples of said display device is selected from a Liquid crystal display (LCD), Light emitting diode display (LED display), organic light emitting display (OLED), micro-LED display, quantum dot display (QLED), AR/VR display, plasma (PDP) display and an electroluminescent (ELD) display.

The present invention is further illustrated by the examples following hereinafter which shall in no way be construed as limiting. The skilled person will acknowledge that various modifications, additions and alternations may be made to the invention without departing from the spirit and scope of the invention as defined in the appended claims.

### EXAMPLES

### Analytics and Measurement Methods

Ellipsometry is used to determine layer thickness, refractive index (n) and absorption index (k) of a metal oxide layer. Measurements are performed using an ellipsometer M2000 from J. A. Woolam and three different angles of incidence (65°, 70° and) 75°. The measurement data is analyzed with software CompleteEase from J. A. Woolam, assuming either full or almost nearly complete transparent behavior above a wavelength of 600 nm and applying B-spline fitting for obtaining refractive indices (n) as well as absorption indices (k). The optical constants are averaged from three to four measured samples each of them providing a different layer thickness either after soft bake or after hard bake or after combined soft and subsequent hard bake.

All chemicals for synthesis described are purchased from Sigma Aldrich and used without further purification, unless differently mentioned elsewhere.

### Preparation Example: Preparation of a Film

A precleaned substrate is loaded with 3 mL of solution consisting of 35 wt % TiOSO₄ in water/PGME/ethyl methyl sulfone (30/60/10 wt. %) solvent blend or 35 wt % TiOSO₄ in water/PGME/cyclohexanone (30/60/10 wt. %) solvent blend. The substrate is then spin-coated at 2000 RPM for 25 sec. Then the substrate is heated at 85° C. for 5 min. followed by 5 minute hard-bake at 300° C. Then Film 1 prepared on the substrate is obtained. In the same manner, in total 6 films (Films 1 to 6) are obtained.

### Materials Used:

The materials and organic solvents are all commercially available and are used in synthesis grade purity. No additional purification is performed prior to their use.

### Preparation of Stock Solution:

175 g TiOSO₄*H₂SO₄*H₂O (CAS-No.: 123334-00-9, Sigma-Aldrich) is dissolved at room temperature in 325 g deionized water to yield a 35 wt % stock solution of TiOSO₄.

### Formulation Preparation:

The stock solution and the organic cosolvents are weighed into a glass bottle and stirred for 30 minutes prior to their use.

### Reference Example 1: Formulation Containing Unstable Cosolvent (PC) that Leads to Evolution of Gas

A formulation composed of 30 wt % stock solution of TiOSO₄, 25 wt % PGME (Propylene glycol monomethyl ether, CAS: 107-98-2), 35 wt % of GBL (gamma-butyrolactone, CAS: 96-48-0) and 10 wt % PC (Propylene carbonate, CAS: 108-32-7) is prepared. Upon storage at room temperature in a closed bottle, pressure buildup could be registered. The atmosphere above the formulation is analyzed to contain an increased amount of carbon dioxide and analysis of the formulation yielded decreasing levels of PC over time. The decomposition of PC in acidic aqueous solution leads to a change in composition over time. This formulation is therefore unstable and not suitable for application.

### Reference Example 2: Formulation Containing Unstable Cosolvent (GBL) that Leads to Increased Viscosity

A formulation composed of 30 wt % stock solution of TiOSO₄ and 70 wt % of GBL (gamma-butyrolactone, CAS: 96-48-0). The initial viscosity after preparation, determined with an Haake Mars Ill rheometer is measured to be 4.24 mPas at 20° C. After storage at room temperature for six days, the viscosity increased to 4.79 mPas. The hydrolysis of GBL to gamma-hydroxy butyric acid in aqueous solution is literature-known and leads to a change in viscosity (DOI: 10.1520/JFS15152J). This leads to a change in the jetting properties and this formulation is not suitable for application.

### Reference Example 3: Stable Formulation that does not Perform Good in IJP Tests

A formulation composed of 30 wt % stock solution of TiOSO₄ and 70 wt % of PGME (Propylene glycol monomethyl ether, CAS: 107-98-2). The initial viscosity after preparation, determined with an Haake Mars Ill rheometer is measured to be 5.47 mPas at 20° C. After storage at room temperature for seven days, the viscosity is still at 5.41 mPas and this formulation is suitable for application test, judged from this property. However, when this formulation is used in IJP experiments, no continuous film is obtained, a strong stripe pattern is visible in the printed film.

### Working Example 1: Formulation Containing 10% EMS

A formulation composed of 30 wt % stock solution of TiOSO₄, 60 wt % of GBL (gamma-butyrolactone, CAS: 96-48-0) and 10 wt % of EMS (Ethyl methyl sulfone, CAS: 594-43-4). The initial viscosity after preparation, determined with an Haake Mars Ill rheometer is measured to be 6.31 mPas at 20° C. After storage at room temperature for six days, the viscosity changed to 6.23 mPas which is within the error margin of the measurement. When the formulation is used in IJP experiments, a continuous film is obtained with significantly improved homogeneity compared to reference example 3.

### Working Example 2: Formulation Containing Cyclohexanone

A formulation composed of 30 wt % stock solution of TiOSO₄, 60 wt % of GBL (gamma-butyrolactone, CAS: 96-48-0) and 10 wt % of CHN (Cyclohexanone, CAS: 108-94-1). The initial viscosity after preparation, determined with an Haake Mars III rheometer is measured to be 5.83 mPas at 20° C. After storage at room temperature for six days, the viscosity changed to 5.84 mPas which is within the error margin of the measurement. When the formulation is used in IJP experiments, a continuous film is obtained with improved homogeneity compared to reference example 3.

What is claimed is:

1. A formulation for preparing an optical layer that includes a metal oxide, comprising;
a material selected from one or more members of the group consisting of metal sulfates, metal phosphates, metal oxy sulfates, metal oxy phosphates, metal oxy chlorides, hydrated metal sulfates, hydrated metal phosphates, hydrated metal oxy sulfates, hydrated metal oxy phosphates and hydrated metal oxy chlorides; and
a chemical compound represented by following chemical formula (I) 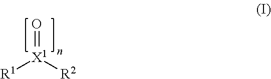
wherein
X¹ is S or C;
n is 2 when X¹ is S, n is 1 when X¹ is C;
R¹ and R² are, independently of each other, selected from the group consisting of a straight-chain alkyl group having 1 to 25 carbon atoms, a branched or cyclic alkyl group having 3-25 carbon atoms, an aryl group having 3 to 25 carbon atoms, a straight chain alkyl-cycloalkyl group having 4 to 25 carbon atoms, a branched chain alkyl-cycloalkyl group having carbon atoms 6 to 25 carbon atoms, a straight chain alkyl-aryl group having 4 to 25 carbon atoms, and a branched chain alkyl-aryl group having 6 to 25 carbon atoms;
wherein one or more non-adjacent CH₂ groups of the above-mentioned groups may be replaced by an oxygen atom, C═O, C═S, C═Se, C═NH, SiH₂, SO, SO₂, OS, or CONH and wherein one or more H atoms may be replaced by D, F, CI, Br, I, CN or NO₂;
wherein each of groups may be substituted by one or more groups R^{a};
R^{a} is at each occurrence, identically or differently, H, D, a straight chain alkyl or alkoxy group having 1 to 15 carbon atoms, a branched or cyclic alkyl or alkoxy group having 3 to 15 carbon atoms, a straight-chain alkenyl or alkynyl group having 2 to 15 carbon atoms, a branched alkenyl group or alkynyl group having 3 to 15 carbon atoms, preferably 3 to 10 carbon atoms, more preferably 3 to 5 carbon atoms, or an aromatic or heteroaromatic ring system having 5 to 15 aromatic ring atoms, wherein for each of the above-mentioned groups, one or more H atoms may be replaced by D, F, Cl, Br, I, and wherein two or more adjacent substituents R^{a} may optionally form a mono- or polycyclic, aliphatic ring system with one another.

2. The formulation of claim 1, wherein the metal of the material is a group 4 element of the periodic table.

3. The formulation of claim 2, wherein the metal of the material is at least one selected from zirconium phosphate, titanyl sulfate (titanium oxysulfate), titanium oxychloride, titanium oxy fluoride, zirconium oxysulfate, zirconium oxychloride, zirconium oxy fluoride and hydrates of any such.

4. The formulation of claim 1, further comprising a solvent that is at least one selected from water, ethylene glycol monoalkyl ethers, ethylene glycol monoethyl ether, ethylene glycol monopropyl ether, ethylene glycol monobutyl ether, diethylene glycol dialkyl ether, diethylene glycol dipropyl ether, diethylene glycol dibutyl ether, propylene glycol monoalkyl ethers, ethylene glycol alkyl ether acetates, propylene glycol alkyl ether acetates, methyl ethyl ketone, acetone, methyl amyl ketone, methyl isobutyl ketone, cyclohexanone, ethanol, propanol, butanol, hexanol, cyclo hexanol, ethylene glycol, propylene glycol, triethylene glycol, glycerin, esters, and cyclic esters.

5. The formulation of claim 1, wherein the compound of formula (I) is represented by following chemical formula (II) or (III)

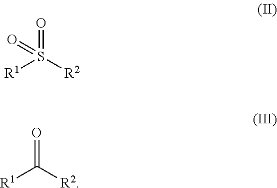

6. The formulation of claim 1, wherein the compound of formula (I) is selected from the group consisting of

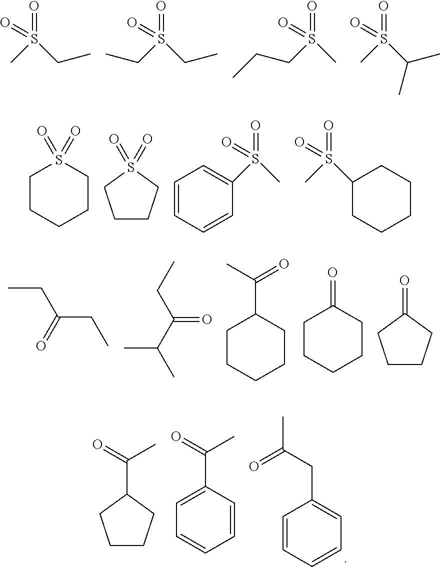

7. The formulation of claim 1, wherein the compound of formula (I) is selected from the group consisting of

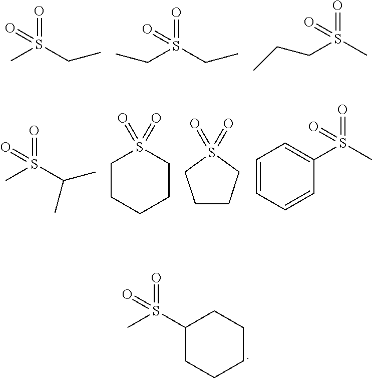

8. The formulation of claim 1, wherein the compound of formula (I) is selected from the group consisting of

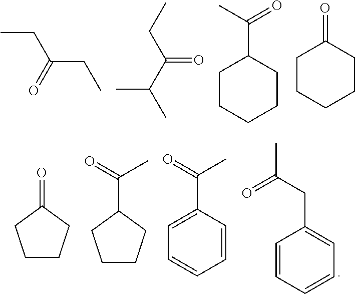

9. The formulation of claim 1, wherein the amount of the chemical compound of formula (I) is in the range from 1 to 15 wt % based on the total amount of the formulation.

10. A method for preparing a formulation of claim 1, which comprises:
mixing a metal oxide salt, a chemical compound of chemical formula (I), and optionally a solvent selected from water, an organic solvent, and a mixture of water and one more organic solvent.

11. A method for preparing a layered composite that includes a metal oxide, comprising:
providing the formulation of claim 1 onto a surface of a substrate; and
applying a thermal treatment to the formulation provided on the surface of the substrate to convert at least a part of the material to a metal oxide.

12. The method according to claim 11, wherein the formulation is applied to the surface of the substrate by spin-coating or ink-jetting.

13. The method according to claim 11, wherein the formulation is at least partly converted on the surface of the substrate to the layered composite by baking it at a temperature from 50 to 300° C.

14. The method according to claim 11, wherein the formulation is at least partly converted on the surface of the substrate to the layered composite, wherein the composite includes a metal oxide.

15. The method according to claim 11, wherein the substrate is a patterned substrate comprising topographical features on the surface thereof.

16. A layered composite obtained or obtainable by the method of claim 11.

17. An optical device comprising the layered composite of claim 16, and a patterned substrate comprising topographical features on the surface thereof.

18. A display device comprising at least one functional medium configured to modulate a light or configured to emit light; and the layered composite of claim 16.
